(19) United States
(12) Patent Application Publication
(10) Pub. No.: US 2021/0249807 A1
(43) Pub. Date: Aug. 12, 2021

(54) ELECTRICAL FIXTURE INSTALLATION SYSTEM AND METHOD

(71) Applicants: Joseph Robert Guy, Lake Forest, CA (US); Brandon Anthony Chavez, Corona, CA (US)

(72) Inventors: Joseph Robert Guy, Lake Forest, CA (US); Brandon Anthony Chavez, Corona, CA (US)

(21) Appl. No.: 17/166,423

(22) Filed: Feb. 3, 2021

Related U.S. Application Data
(60) Provisional application No. 62/972,748, filed on Feb. 11, 2020.

(51) Int. Cl. H01R 13/24; H01R 13/436; H01R 13/518

(52) U.S. Cl. CPC H01R 13/2492; H01R 13/2485; H01R 2103/00; H01R 13/518; H01R 13/4365

(57) ABSTRACT

A two-piece electrical locking system having a first male piece with a plurality of pins that protrude outwardly from a top surface of the first male piece and a second female piece with a plurality of connection channels that engage with the pins of the first male piece. The first male piece may be tightened and brought closer to the second female piece as the pins rotatably mate with the plurality of connection channels. The two-piece electrical locking system may allow for an electrical fixture to easily and effectively be connected mechanically and electrically to an overhead junction box.

### CROSS-REFERENCE TO RELATED APPLICATIONS

This application claims the benefit of U.S. Provisional Application No. 62/972,748, filed Feb. 11, 2020, which is hereby incorporated by reference, to the extent that it is not conflicting with the present application.

### BACKGROUND OF INVENTION

### 1. Field of the Invention:

The invention relates generally to electrical fixtures and more specifically to a two-piece locking system for installation of electrical fixtures.

### 2. Description of the Related Art

Currently, the installation of electrical fixtures (e.g., light fixtures, chandeliers, ceiling fans) is a physically involved and time-consuming task that usually requires, at minimum, two people to effectively and safely complete. Attempting to install a light fixture into a ceiling without two people would require a single person to hold the light fixture, which could weigh upwards of 50 pounds, with one hand while trying to screw in a small screw into an overhead junction box with the other hand. The lone installer may also be standing on a ladder, which only makes the task more difficult and unsafe. Furthermore, once the fixture is successfully screwed into the overhead junction box, the installer must still connect the electrical wires of the electrical fixture to the junction box electrical connectors, and then cram the connected wires into the junction box. Such a process may require a homeowner or business owner to hire electricians to safely and properly install the electrical fixture, incurring labor costs for at least two people.

Additionally, depending on the size and length of the electrical fixture, a gap may appear between the electrical fixture canopy and the ceiling after installation, rendering the electrical fixture aesthetically unappealing. Furthermore, some electrical fixtures, depending on the oriental design of the fixture, may need to be aligned in a particular rotational fashion to aesthetically align the fixture with the canopy or an object below, which may not possess a round/circular design. As such, it can be particularly challenging to align the fixture with the shape of the canopy, or with the object below the fixture (e.g., a table), especially after the fixture has already been screwed into the overhead junction box.

Furthermore, due to earthquakes and/or natural vibrations of homes and buildings, installed electrical fixtures may slightly shift, resulting in a tilted or low-hanging appearance. Natural vibrations could also cause wiring to come undone, resulting in a loss of electrical connection. Currently, shifted or disconnected electrical fixtures may need to be removed from the junction box and linearly realigned or reconnected to correct the awkward appearance of the fixture and/or the electrical disconnection. This process can be tedious and time-consuming to complete, especially for one person.

Therefore, there is a need to solve the problems described above by providing a two-piece electrical locking system and method for effectively and easily installing electrical fixtures.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description.

In an aspect, a two-piece electrical locking system is provided. The two-piece electrical locking system may be provided with a first male piece and a second female piece. The male piece may be provided with at least two pins that protrude outwardly from a top surface of the piece. These pins may be coated with or manufactured from an electrically conductive material and may include an enlarged head at their distal ends. The pins may connect electrically to wires that are a part of an electrical fixture. The female piece may be provided with at least two connection channels that engage with the pins of the male piece. The connection channels may be provided with a sloping thickness, such that the male piece is tightened and brought closer to the female piece as the pins rotatably mate with the female channels. The female piece may also be provided with metal half-rings coated with or manufactured from an electrically conductive material. The metal half-rings may be disposed around a center hole in the female piece and may connect electrically to wires that are a part of an overhead junction box. The metal half-rings establish an electrical connection with the pins of the male piece when the pins are rotatably locked into the female connection channels. The female piece may also be provided with a plurality of notches that line the female channels and are configured to hold the enlarged heads of the pins of the male piece in place. The plurality of notches may allow the male piece, and therefore the electrical fixture to which it connects, to be rotated to linearly align the electrical fixture, while maintaining the mechanical and electrical connection between the two pieces. Thus, an advantage of the two-piece electrical locking system is that an electrical fixture may easily and effectively be connected mechanically and electrically to an overhead junction box. Another advantage is that the electrical fixture may be easily rotated to align the fixture with a canopy or an object below the fixture. An additional advantage is that the notches of the female piece may prevent the electrical fixture from shifting due to vibrations of a home or building. Another advantage is that any gap between the canopy of the electrical fixture and the ceiling may be closed. Another advantage is that the two-piece electrical locking system provides a universal fit and may be adapted to be used on all mounting hardware styles and electrical fixture designs currently available in the marketplace.

In another aspect, a method of installing an electrical fixture using the two-piece electrical locking system is provided. First, the male piece may be connected electrically and installed in the canopy of an electrical fixture, such that the pins are oriented upward. The female piece may be connected electrically and installed in an overhead junction box, such that the metal half-rings face upwardly toward the ceiling. A user may then lift the electrical fixture upward toward the junction box and insert the heads of the pins of the male piece into the connection channels of the female piece. Once the pins have been inserted into the channels, the user may rotate the electrical fixture to align and raise the fixture into a preferred orientation. Finally, the user may lock the electrical fixture into place and secure the canopy over the junction box. Thus, an advantage is that the two-piece electrical locking system may allow a single user to install an electrical fixture easily and effectively. Another advantage is that the need to connect wires of the electrical fixture to junction box electrical connectors after mounting the electrical fixture may be negated. An additional advantage is that a user may easily rotate the electrical fixture to reorient the fixture, even after the fixture has been installed. An additional advantage is that the electrical fixture may be easily replaced without the need for hiring an electrician.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1 illustrates a perspective view of a two-piece electrical locking system in an unlocked state, according to an aspect.

FIG. 2 illustrates a perspective view of a male piece of the two-piece electrical locking system shown in FIG. 1, according to an aspect.

FIG. 3 illustrates a bottom perspective view of a female piece of the two-piece electrical locking system shown in FIG. 1, according to an aspect.

FIGS. 4A-4B illustrate bottom and top perspective views, respectively, of the two-piece electrical locking system in a locked state, according to an aspect.

FIGS. 5A-5B illustrate perspective views of the two-piece electrical locking system installed in a junction box in unlocked and locked states, respectively, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

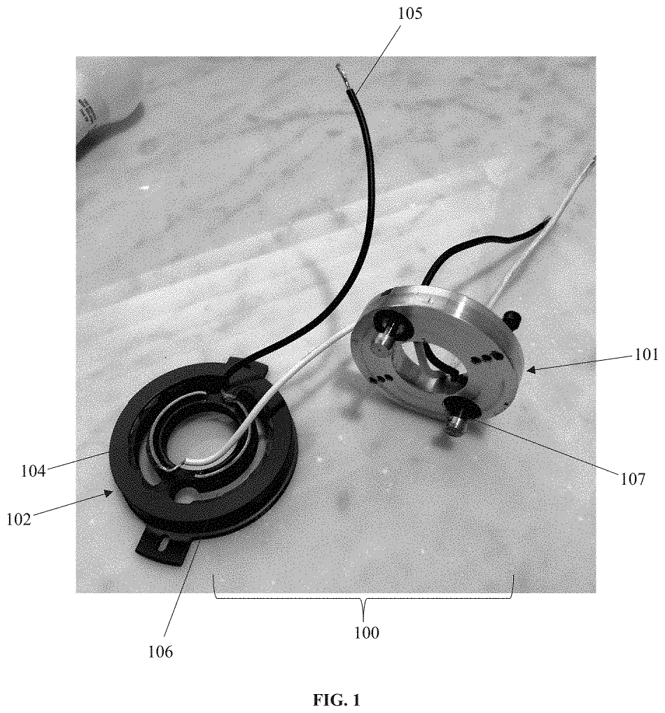

FIG. 1 illustrates a perspective view of a two-piece electrical locking system 100 in an unlocked state, according to an aspect. As shown in FIG. 1, the two-piece electrical locking system (“two-piece electrical locking system,” “two-piece system,” “electrical locking system,” “locking system”) may comprise a first male piece 101 and a second female piece 102. As shown, each piece 101, 102 may be provided with at least a couple wires 105 (positive and ground) that enable the pieces 101, 102 to connect electrically to external devices (i.e., junction box and electrical fixture), as an example. As will be discussed in more detail throughout this disclosure, the male piece 101 may connect mechanically and electrically to the female piece 102 to enable easy and effective installation of electrical fixtures.

As shown, the male piece 101 may be provided with a couple pins 107. The female piece 102 may be provided with a couple connection channels (“connection channels,” “female channels”) 106 that are configured to receive the pins 107 of the male piece 101. The female piece 102 may also be provided with a couple metal half-rings 104 that may connect electrically to the male pins 107. As will be discussed in further detail below, the pins 107 of the male piece 101 may be inserted into and rotated within the female channels 106 to establish the mechanical and electrical connection between an electrical fixture and a junction box. The two-piece locking system 100 may be manufactured from a combination of various exemplary materials, such as steel, copper, aluminum, plastics, composites, and more.

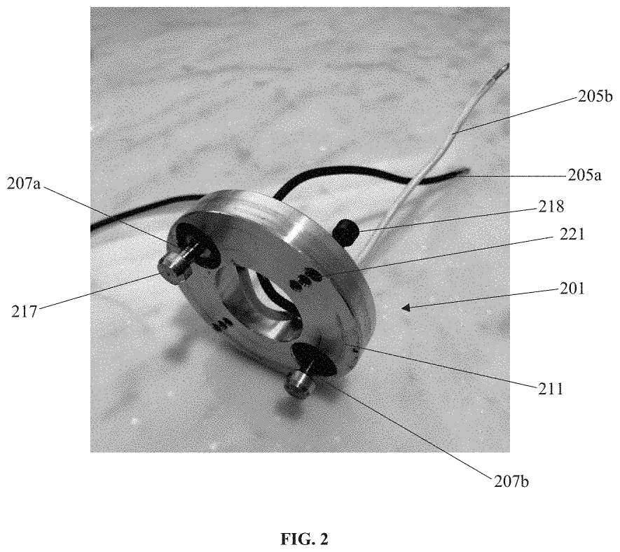

FIG. 2 illustrates a perspective view of a male piece 201 of the two-piece electrical locking system 100 shown in FIG. 1, according to an aspect. As mentioned previously above, the male piece 201 may be provided with a couple pins 207a, 207b protruding outwardly from the top surface 211, as shown. As shown, the male pins 207a, 207b may each comprise an enlarged head 217, which functions to lock the male piece 201 into the female piece (102 in FIG. 1), as an example. Furthermore, the pins 207a, 207b may be coated with or manufactured from a conductive material (e.g., copper), which allows current from the junction box to flow into the electrical fixture when the two-piece locking system is interlocked, as an example.

As shown in FIG. 2, the male piece 201 may also comprise a couple wires 205a, 205b. Each wire may connect electrically to a pin; as an example, the ground wire 205a may connect to the pin 207a and the positive wire 205b may connect to the pin 207b, as shown. The wires may be soldered to the ends (not shown) of the pins 207, as an example, and composite or compound material may be applied around the pins and the wires to further hold them in place. The wires 205a, 205b may also connect electrically to an electrical fixture, such that current may flow through the pins 207 to the electrical fixture, as an example.

The male piece 201 may also comprise a number of surface mounting holes 221, as shown in FIG. 2. As an example, the surface mounting holes 221 may be disposed in the body of the male piece 201 to support threaded screws or bolts 218. The surface mounting holes 221 may allow a mounting plate to be screwed to the bottom surface of the male piece, which allows the male piece to be installed in the canopy of an electrical fixture, as an example.

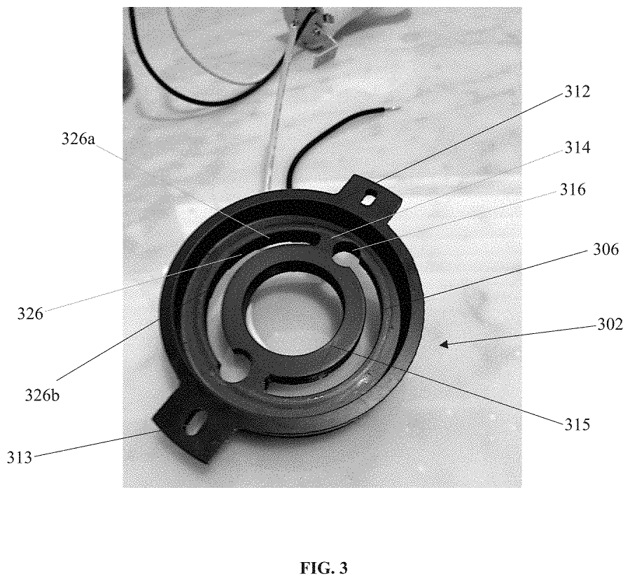

FIG. 3 illustrates a bottom perspective view of a female piece 302 of the two-piece electrical locking system 100 shown in FIG. 1, according to an aspect. As shown in FIG. 3, the bottom portion of the female piece 302 may comprise two surfaces, a lower surface 314 and an upper surface 312 raised above the lower surface 314. As described previously when referring to FIG. 1, the female piece 302 may be provided with a couple of connection channels 306, as shown. The connection channels 306 may be disposed in the bottom surface 314 and may line a center hole 315 of the female piece 302, as an example. As will be discussed in further detail herein below, the inner diameter of the center hole 315 may help direct wires and support hardware typically provided on most electrical fixtures. As an example, each channel 306 may also be provided with an enlarged circular opening 316, as shown. The enlarged circular opening 316 of each channel 306 may comprise a diameter large enough to receive the enlarged head of each pin of the male piece (shown by 217 in FIG. 2). As shown, the remaining open portion of each connection channel 306 may be thinner than the circular opening 316, such that when the male pins are inserted into the female channels 306 and rotated, the heads of the pins will remain tightly engaged within the channels, as an example. The tight engagement of the pins within the channels will allow the weight of an electrical fixture to be securely supported by the two-piece locking system.

As shown in FIG. 3, each connection channel 306 may also be provided with inner walls 326 comprising a sloping thickness. As shown as an example, the portion of the inner wall 326 shown at 326a is thicker than the portion of the inner wall shown at 326b. The sloping thickness of the inner walls 326 of each channel 306 functions to raise the male piece toward the female piece as the male piece is rotated up to 180 degrees. As an example, after the pins are inserted into the receiving enlarged openings 316 of the channels, the male piece may be rotated to secure the pins within the channels 306. As the male piece is rotated clockwise, the thickness of the inner walls of the channels increases, as shown, resulting in the male piece being brought closer to and held tighter within the female piece 302. Because the female piece is installed in a junction box and the male piece is installed in an electrical fixture, the increasing thickness causes the electrical fixture to rise toward the junction box, and therefore toward the ceiling, as an example. Thus, an advantage of the sloping thickness of the female channels is that any gap between the canopy of the electrical fixture and the ceiling may be closed.

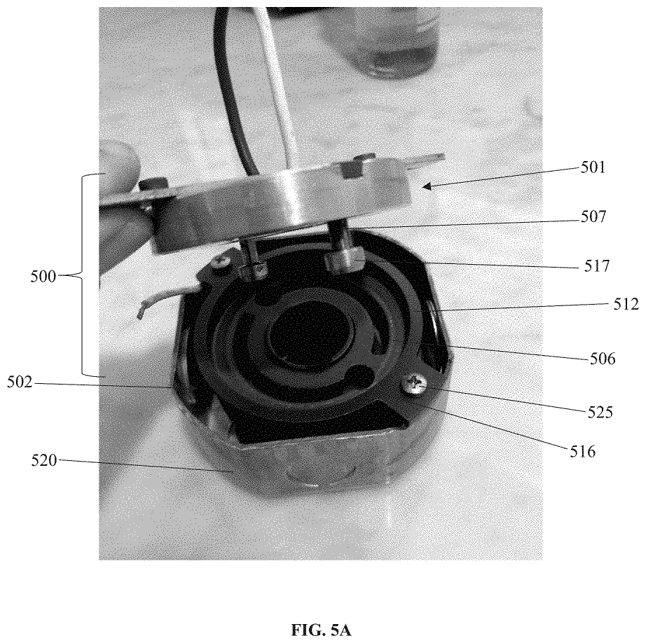

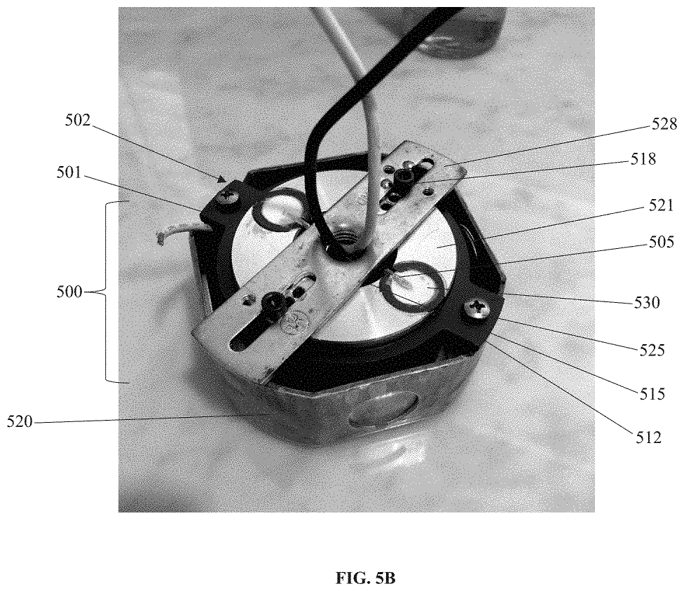

Finally, as described above, the female piece 302 may also comprise the raised upper surface 312, as shown in FIG. 3. The raised upper surface 312 may comprise a diameter large enough to receive the male piece, which will be discussed when referring to FIGS. 5A-5B. The diameter of the upper surface allows the female piece 302 to fit snugly around the male piece, which may aid in the aligning and inserting of the male pins into the female channels, as an example. As shown, the upper surface 312 may also comprise a number of outer mounting holes 313, as an example. The outer mounting holes 313 may allow the female piece 302 to be installed in a junction box, which will be discussed further when referring to FIGS. 5A-5B.

In a preferred embodiment of the present invention, the raised upper surface 312 may be manufactured from metal, while the lower surface is made of a non-metal material (e.g., plastic). The metal upper surface may include a small contact that will ground the male piece to both the female piece 302 and the junction box, as an example, when the male piece is locked into the female piece.

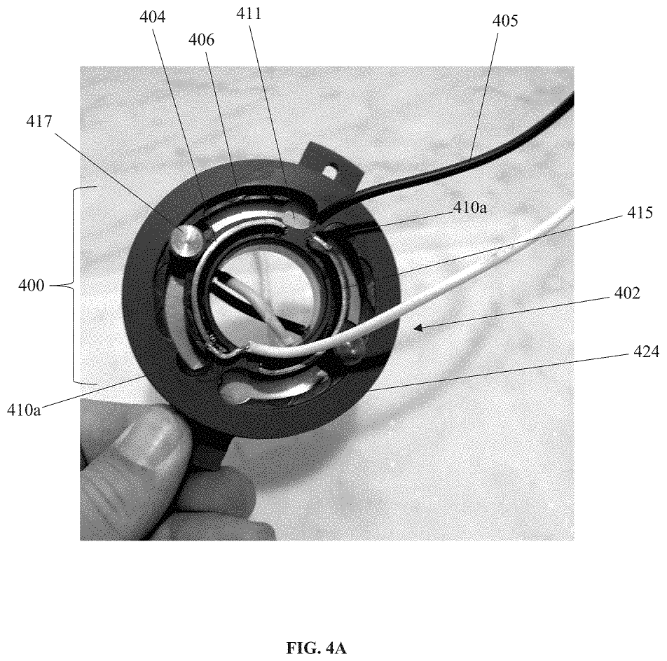

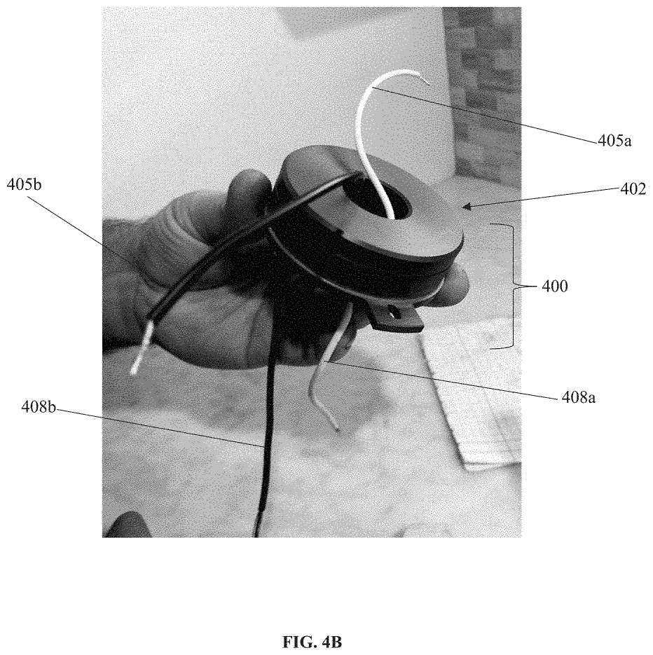

FIGS. 4A-4B illustrate bottom and top perspective views, respectively, of the two-piece electrical locking system 400 in a locked state, according to an aspect. As shown in FIG. 4A, the male piece may interlock with the female piece 402, wherein the pin heads 417 of the male piece have been rotated within the female channels 406. As shown, the female channels 406 may comprise a number of notches 410 disposed in the bottom surface 424 of the female piece 402. As an example, the notches 410 may be disposed along each connection channel at about every ⅛ inches, as shown. The notches 410 resemble circular dents in the surface 424 of the female piece 402 and function to hold and support the heads 417 of the male pins, as shown. As an example, the bottom of each head 417 may rest snugly in one of the notches 410 that line each connection channel 406, which may prevent the male piece from moving or shifting during use (e.g., due to an earthquake). As such, the user must apply direct upward force and then rotational motion to adjust the placement of the male piece connected to an electrical fixture.

The user may rotate the male piece along the connection channels 406 to align the electrical fixture over an object (e.g., a table) or to close the gap between the canopy of the electrical fixture and the ceiling. As an example, the user may rotate the male piece, after insertion of the pins, clockwise up to 180 degrees along the connection channels 406 and align the heads 417 into the final notches 410a, such that the top surface 411 of the male piece is flush with the lower surface of the female piece (shown by 314 in FIG. 3). Therefore, an advantage of the two-piece locking system 400 is that the electrical fixture may be easily rotated to align the fixture with a canopy or an object below the fixture. An additional advantage is that the notches of the female piece may prevent the electrical fixture from shifting due to natural vibrations of a home or building.

As shown in FIG. 4A, the bottom surface 424 of the female piece 402 may also be provided with a couple of metal half-rings 404. The metal half-rings 404 may line the center hole 415, such that they may make direct contact with the heads 417 of the pins after insertion of the male piece into the female piece 402. The metal half-rings 404 may be coated with or manufactured from a conductive material (e.g., copper) to enable current to flow from the rings 404 to the pins 417 after contact. As shown as an example, a wire 405 may be soldered to an end of each metal half-ring 404, such that current can flow from a junction box continuously into an electrical fixture when direct contact between the pins and the metal half-rings is established.

As shown in FIG. 4B, the male piece may be locked into place within the female piece 402 while simultaneously making an electrical connection. As an example, the wires 405a, 405b connected to the female piece 402 may be electrically connected to an overhead junction box. The wires 408a, 408b may be electrically connected to an electrical fixture. As described above, current flowing from the junction box may flow through the wires into the electrical fixture via the two-piece locking system 400. It should be understood that current cannot flow from the junction box to the electrical fixture when the pins and the rings are not in direct contact. Thus, an advantage of the two-piece electrical locking system 400 is that an electrical fixture may easily and effectively be connected mechanically and electrically to an overhead junction box.

FIGS. 5A-5B illustrate perspective views of the two-piece electrical locking system 500 installed in a junction box 520 in unlocked and locked states, respectively, according to an aspect. As shown in FIG. 5A, the female piece 502 of the two-piece locking system 500 may be installed in an exemplary junction box 520. As described previously when referring to FIG. 3, the female piece may be installed in a junction box via the outer mounting holes (shown by 313). As an example, a screw 525 may be inserted into each outer mounting hole in the raised surface 512 of the female piece 502, as shown, to attach the female piece 502 to the junction box 520. While a rectangular junction box is illustrated in FIGS. 5A-5B, it should be understood that the female piece 502 may be installed in a junction box of any shape and/or size.

As shown in FIG. 5A, the heads 517 of the pins 507 may be aligned with the enlarged circular openings 516 of the connection channels 506 to insert the male piece 501 into the female piece 502. As described previously above, the pins 507 may be rotated clockwise up to 180 degrees along the female channels 506 to lock and fix the male piece 501 to the female piece 502, as an example.

As shown in FIG. 5B, the male piece 501 may fit snugly into the diameter of the raised surface 512 of the female piece 502. The fit between the two pieces is not a tight seal, however, and the male piece 501 may still be rotated within the female piece 502 to adjust the orientation of an electrical fixture attached to the junction box 520. As described previously when referring to FIG. 2, the male piece may be installed in the canopy of an electrical fixture via the surface mounting holes (shown by 221). As an example, screws 518 may be inserted through a mounting plate or tab 528 and screwed into the surface mounting holes, as shown. The mounting tab or plate 528 may then be screwed to the canopy of an electrical fixture, thus installing the male piece within the electrical fixture, as an example. Thus, an advantage is that the two-piece electrical locking system 500 provides a universal fit and may be adapted to be used on all mounting hardware styles and electrical fixture designs currently available in the marketplace.

As was previously discussed, electrical wires may be connected to the pins of the male piece 501 to transfer current through the pins. As shown in FIG. 5B as an example, an end of a wire 505 may be soldered to the back of a pin and further applied with a composite material 530 to secure the wire 505 to the pin. The composite material 530 may also hold the pins in place in the male piece, as an example. Additionally, the wires 505 may be directed through the inner diameter of the center hole 515 of the male piece 502 to electrically attach the wires to electrical connections inside the electrical fixture, as an example.

In another aspect of the current invention, a method of installing an electrical fixture using the two-piece electrical locking system 500 is provided. As previously mentioned above, the male piece 501 may first be connected electrically and installed in the canopy of an electrical fixture on the ground, such that the pins 507 are oriented upward. The female piece 502 may be connected electrically and installed in an overhead junction box 520, such that the metal half-rings face upwardly toward the ceiling. A user may then lift the electrical fixture upward toward the junction box 520 and insert the heads 517 of the pins 507 of the male piece 501 into the enlarged openings 516 of the connection channels 506 of the female piece 502. Once the pins 507 have been inserted into the enlarged openings 516, the user may rotate the electrical fixture clockwise up to 180 degrees to slide the pins 507 along the channels 506, until the electrical fixture is aligned and raised up into a preferred orientation. Finally, the user may lock the electrical fixture into place by positioning the heads 517 of the pins 507 into notches of the channels (shown by 410 in FIG. 4), and then securing the canopy over the junction box 520. Because of the indented nature of each notch, the user will be able to feel the placements of the heads into the notches as the fixture is rotated. Thus, an advantage is that the two-piece electrical locking system may allow a single user to install an electrical fixture easily and effectively. Another advantage is that the need to connect wires of the electrical fixture to electrical connectors in a junction box after mounting the electrical fixture may be negated.

Once the electrical fixture has been installed into the junction box using the two-piece locking system disclosed herein above, the user may need to readjust or realign the fixture at a later point. The electrical fixture may need to be rotated to align the fixture aesthetically with a specifically shaped canopy or piece of furniture. Moreover, the fixture may not be round or symmetrical, requiring further realignment. Rather than having to uninstall the electrical fixture completely, the two-piece locking system may be configured to rotate counterclockwise, allowing the user to rotate and reorient the fixture without disrupting the existing connection. In another example of the present invention, the female piece may comprise two separate pieces. As discussed previously when referring to FIG. 3, the female piece may include outer mounting holes in the upper surface (312) that enable the female piece to be installed in a junction box. Rather than having an upper surface and a lower surface, the female piece may be provided with a top bracket (not shown) and a bottom disc (not shown). The top bracket may be manufactured separately from the bottom disc, such that the two pieces form the female piece when joined together. The top bracket may be made out of metal and may include mounting points that enable the interconnected female piece to be installed in a junction box. The bottom disc may be provided with the connection channels, notches and electrical hardware described herein above. The top bracket and the bottom disc may be connected together via a connection point at their respective centers (similar to 315 in FIG. 3), such that when the two pieces are connected, a central opening is still available to support hardware provided on most electrical fixtures, as an example.

The connection point between the top bracket and the bottom disc may be provided with indentations similar to those found in the gears of ratchets, for example, that enable the bottom disc to rotate with respect to the top bracket. As discussed above, after the two-piece locking system has been implemented for installing an electrical fixture, the user may rotate the fixture clockwise up to 180 degrees to lock the fixture into place until the canopy reaches the ceiling, as an example. Once the fixture has been locked into place, the user may then rotate the whole fixture counterclockwise up to 340 degrees along the indentations of the connection point in the female piece. As in a ratchet, for example, the bottom disc of the female piece will click at each indentation of the connection point during rotation, preventing the fixture from being rotated back in the opposite direction (i.e., clockwise). The connection point may be provided with a stopping point at 340 degrees (with respect to the rotational starting point) to prevent the bottom disc from rotating any further. As an example, if the user desires to replace or remove the electrical fixture, the user may rotate the fixture beyond the 340-degree stopping point to then rotate the pins of the male piece counterclockwise along the connection channels until the male piece is dislodged from the female piece. Thus, an advantage is that a user may easily rotate the electrical fixture to reorient the fixture, even after the fixture has been installed. An additional advantage is that the electrical fixture may be easily replaced or removed without the need for hiring an electrician.

It should be understood that although the two-piece locking electrical system disclosed herein above is depicted using wires to establish electrical connections, alternate forms of electrical connections, including a greater/lesser number of wires, could be used. Additionally, while the male and female pieces are depicted having an overall circular shape, the pieces could be adapted to have a square, rectangular, or other shape while still accomplishing the same functionality. Furthermore, the two-piece locking system may be adapted to be installed in junction boxes and/or electrical fixtures via means other than screws, mounting holes, and mounting plates, as depicted herein.

It should also be understood that although the present invention was described in its application in overhead junction boxes, the two-piece locking system could easily be adapted to establish mechanical and electrical connections for wall sconces and other hanging wall fixtures.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. As used in this application, “and/or” means that the listed items are alternatives, but the alternatives also include any combination of the listed items.

The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. The terms “comprising,” “including,” “carrying,” “having,” “containing,” “involving,” and the like are to be understood to be open-ended, i.e., to mean including but not limited to. Only the transitional phrases “consisting of” and “consisting essentially of” respectively, are closed or semi-closed transitional phrases.

Throughout this description, the aspects, embodiments or examples shown should be considered as exemplars, rather than limitations on the apparatus or procedures disclosed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples.

What is claimed is:

1. A two-piece electrical locking system comprising a first male piece having a plurality of pins that protrude outwardly from a top surface of the first male piece and a second female piece having a plurality of connection channels that engage with the pins of the first male piece; the first male piece is tightened and brought closer to the second female piece as the pins rotatably mate with the plurality of connection channels.
